(19) United States
(12) Patent Application Publication
(10) Pub. No.: US 2025/0321640 A1
(43) Pub. Date: Oct. 16, 2025

(54) TOUCH PANEL ASSEMBLY

(71) Applicant: Acer Incorporated, New Taipei City (TW)

(72) Inventor: Yan-Lin KUO, New Taipei City (TW)

(73) Assignee: Acer Incorporated, New Taipei City (TW)

(21) Appl. No.: 19/079,092

(22) Filed: Mar. 13, 2025

(30) Foreign Application Priority Data
Apr. 11, 2024 (TW) 113113528

(51) Int. Cl. G06F 3/01; G06F 3/041

(52) U.S. Cl. CPC G06F 3/016; G06F 3/041; G06F 2203/04105

(57) ABSTRACT

A touch panel assembly is provided and comprises a touch panel module, a touch panel base and an abutting structure. The touch panel module is arranged on the touch panel base and includes a lever member and a circuit board. The lever member is adhered to the circuit board. The circuit board includes a triggering element. When the touch panel module is pressed, the lever member is in contact with the triggering element. The abutting structure is disposed in the touch panel base, abuts against the lever member, and is detachable and optionally mounted at a plurality of different positions of the touch panel base. Corresponding to the abutting structure being at the different positions of the touch panel base, the abutting structure abuts on different portions of the lever member, so that different pressing hand-feelings are provided when the lever member is in contact with the triggering element.

This application claims the benefits of the Taiwan application Serial No. 113113528 filed on Apr. 11, 2024, the disclosure of which is incorporated by reference herein in its entirety.

### TECHNICAL FIELD

The present invention relates to a touch panel assembly, and in particular relates to a touch panel assembly for laptop computers.

### BACKGROUND

In the field of touch panels, the current common design is that at a switch element for touch sensing, a housing of a laptop computer is usually provided with a corresponding protrusion to be in contact with and trigger the switch element, but the position of this protrusion on the housing is fixed and cannot be adjusted, so the current touch panel provides a fixed pressing feel. In view of this, those skilled in the art strive to achieve how to improve the current touch panel to obtain a product with adjustable pressing hand-feelings.

### SUMMARY

The present invention is directed to provide a novel touch panel assembly, in order to achieve an adjustable pressing hand-feeling by modifying the magnitude of the support moment of force of the touch panel module.

According to one aspect of the present invention, a touch panel assembly is provided. The touch panel assembly comprises a touch panel module, a touch panel base and an abutting structure. The touch panel module is arranged on the touch panel base and includes a lever member and a circuit board. The lever member is adhered to the circuit board. The circuit board includes a triggering element. When the touch panel module is pressed, the lever member is in contact with the triggering element. The abutting structure is disposed in the touch panel base, abuts against the lever member, and is detachable and optionally mounted at a plurality of different positions of the touch panel base. Corresponding to the abutting structure being at the different positions of the touch panel base, the abutting structure abuts on different portions of the lever member, so that different pressing hand-feelings are provided when the lever member is in contact with the triggering element.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1A and FIG. 1B are three-dimensional schematic diagrams of a touch panel module of a touch panel assembly according to an embodiment of the present invention.

FIG. 2A is a three-dimensional schematic diagram of a touch panel base and an abutting structure of a touch panel assembly according to an embodiment of the present invention.

FIG. 2B is a partial enlarged view of the touch panel base and the abutting structure in FIG. 2A.

FIG. 2C is a partial enlarged view of the touch panel base in FIG. 2A.

FIG. 2D is a three-dimensional schematic diagram of a supporting structure of a touch panel assembly according to an embodiment of the present invention.

FIG. 3A is a partial side view of the touch panel module of the touch panel assembly in FIG. 1B.

FIG. 3B is a partial side view of the touch panel module of the touch panel assembly in FIG. 1A.

### DETAILED DESCRIPTION

Detailed descriptions of the embodiments of the specification are disclosed below with reference to the accompanying drawing. Apart from the said detailed descriptions, any embodiments in which the present invention can be used as well as any substitutions, modifications or equivalent changes of the said embodiments are within the scope of the disclosure, and the descriptions and definitions in the claims shall prevail. In the following detailed description, for purposes of explanation, numerous specific details are set forth in order to provide a thorough understanding of the disclosed embodiments. It will be apparent, however, that one or more embodiments may be practiced without these specific details. Additionally, well-known common steps or components are not described in detail to avoid unnecessarily limiting the present invention. The same or similar elements in the figures are represented by the same or similar sign.

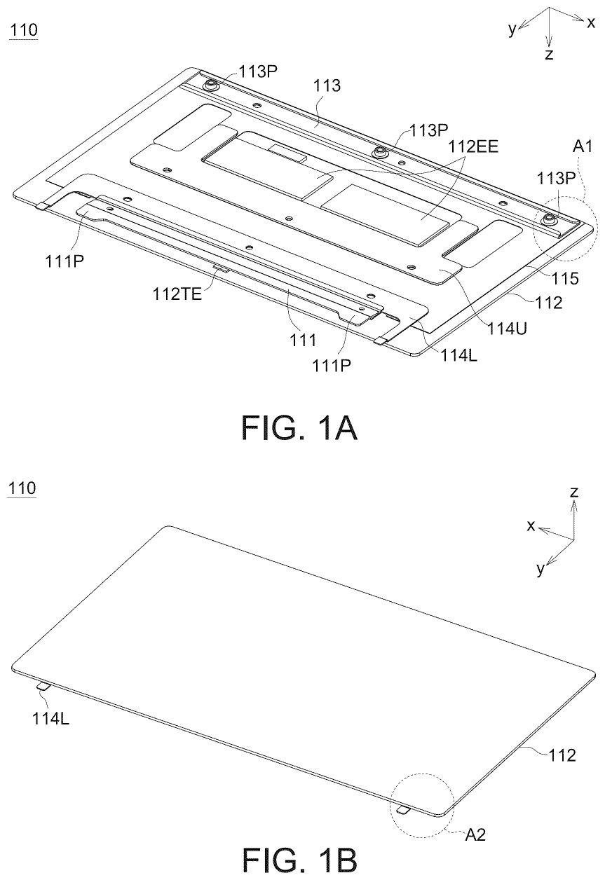

Please refer to FIG. 1A and FIG. 1B, which are three-dimensional schematic diagrams of the touch panel module 110 of the touch panel assembly according to an embodiment of the present invention. FIG. 1A shows the bottom side of the touch panel module 110. FIG. 1B shows the top side of the touch panel module 110 opposite to the bottom side.

The touch panel assembly of embodiments can be applied to a laptop computer, providing haptic sensing functionality for operations such as cursor control or pressing. The touch panel assembly may include the touch panel module 110. The touch panel module 110 may include the lever member 111, the circuit board 112, the supporting strip 113, the supporting members (including the upper supporting member 114U and the lower supporting member 114L), and the flexible sheet 115. The lever member 111, the supporting strip 113, the upper supporting member 114U, and the lower supporting member 114L are adhered to the circuit board 112, specifically via the flexible sheet 115. The flexible sheet 115 may be designed to have adhesiveness only at the connection area with the lever member 111, the supporting strip 113, the upper supporting member 114U, and the lower supporting member 114L and the circuit board 112, while other areas may be non-adhesive. The contact surface between the flexible sheet 115 and the circuit board 112 is adhesive except for the areas opposite the lever member 111 and the supporting strip 113, allowing the lever member 111 and the supporting strip 113 to pivot on the circuit board 112. For example, the flexible sheet 115 may be a Mylar double-sided adhesive tape.

The circuit board 112 may be a printed circuit board (PCB) and include the triggering element 112TE and the electronic element 112EE. The triggering element 112TE, for instance, may be a metal dome serving as a press switch. The lever member 111 may be a metallic component. When the touch panel module 110 is pressed, the lever member 111 is in contact with the triggering element 112TE to activate the corresponding touch function. The upper supporting member 114U is positioned above the electronic element 112EE, or the electronic element 112EE may be said to be accommodated within the boundary defined by the inner edge of the upper supporting member 114U. The lower supporting member 114L is positioned above the lever member 111, or the lever member 111 may be said to be accommodated within the boundary defined by the inner edge of the lower supporting member 114L. The upper supporting member 114U and the lower supporting member 114L may be made of metallic material, providing structural rigidity to the touch panel module 110 and physically protecting the electronic element 112EE and the lever member 111.

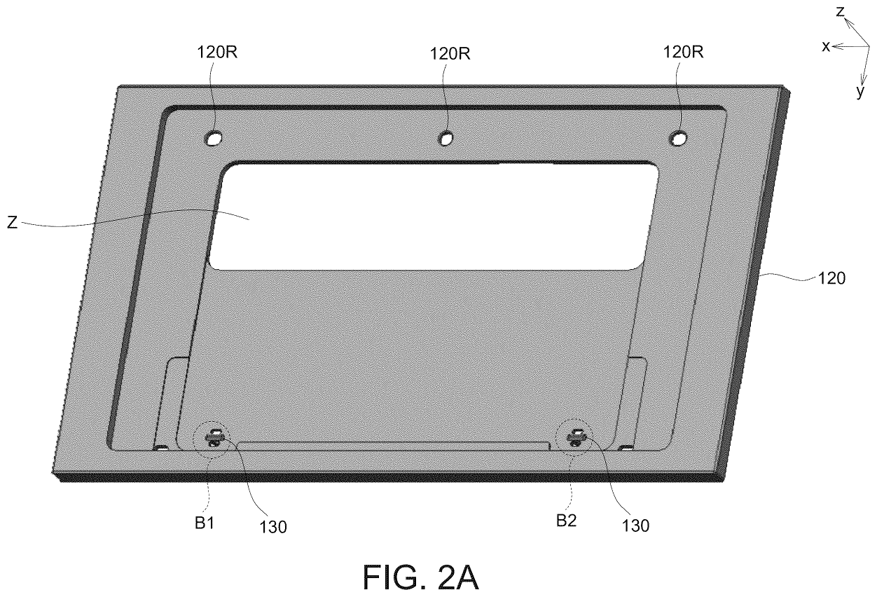

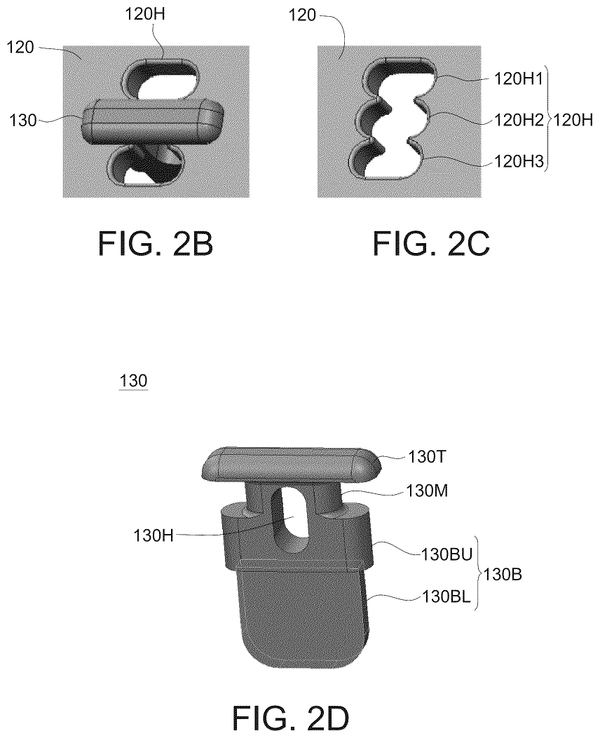

Please also refer to FIGS. 2A to 2D. FIG. 2A illustrates a three-dimensional schematic diagram of the touch panel base 120 and the abutting structure 130 of the touch panel assembly according to an embodiment of the present invention. FIG. 2B illustrates a partial enlarged view of partial areas B1 and B2 of the touch panel base 120 and the abutting structure 130. FIG. 2C illustrates a partial enlarged view of the mounting hole 120H of the touch panel base 120. FIG. 2D illustrates a three-dimensional schematic diagram of the abutting structure 130.

The touch panel assembly may further include the touch panel base 120 and the abutting structure 130. The touch panel module 110 may be disposed on the touch panel base 120. Specifically, as shown in FIG. 1B, the protruding portions formed on both sides of the lower supporting member 114L may first be placed into corresponding grooves of the touch panel base 120 to prevent the touch panel module 110 from being elevated above the upper surface of the touch panel base 120. Thus, the touch panel module 110 can be disposed on the touch panel base 120 with its bottom side facing the touch panel base 120. In detail, the protruding portions on both sides of the lower supporting member 114L may be elastic to prevent the touch panel module 110 from being lifted upward after being placed into the touch panel base 120. The touch panel base 120 may be made of plastic or metal alloy and is suitable for installation on portions of a laptop computer that are commonly known as the C-cover and D-cover. The touch panel base 120 may include a hollow zone Z. When the touch panel module 110 is disposed on the touch panel base 120, the electronic element 112EE of the circuit board 112 may pass through the hollow zone Z, thereby reducing the overall thickness of the touch panel assembly and enabling a thinner product design. Furthermore, the touch panel base 120 may include base the fixing hole 120R. In this embodiment, the number of the base fixing hole 120R is three, and these three base fixing holes 120R are arranged on the upper side of the touch panel base 120.

The abutting structure 130 may be disposed in the touch panel base 120. For example, the abutting structure 130 may be made of rubber material. When the touch panel module 110 is placed on the touch panel base 120, the abutting structure 130 abuts against the lever member 111. In this embodiment, there are two abutting structures 130, each arranged on one side of the touch panel base 120 to provide support for the two protruding ends 111P of the lever member 111. The touch panel base 120 includes the mounting hole 120H corresponding to the abutting structure 130, and the abutting structure 130 can be secured within the mounting hole 120H. The mounting hole 120H may include a plurality of accommodating portions, such as accommodating portions 120H1, 120H2, and 120H3. The accommodating portions 120H1, 120H2, and 120H3 are arranged along the extension direction of the protruding end 111P. The abutting structure 130 are detachable and optionally mounted in the accommodating portion 120H1, 120H2, or 120H3 to change the abutment position of the protruding end 111P of the lever member 111.

That is, the abutting structure 130 are detachable and can be optionally mounted at various positions within the touch panel base 120 (e.g., secured within the accommodating portion 120H1, the accommodating portion 120H2, or the accommodating portion 120H3). Corresponding to the abutting structure 130 being at different positions of the touch panel base 120, the abutting structure 130 abuts on different portions of the lever member 111, resulting in different lever arm lengths and corresponding moment of force values. As such, different pressing hand-feelings are provided when the lever member 111 is in contact with the triggering element 112TE.

The abutting structure 130 includes the top portion 130T, the middle portion 130M and the bottom portion 130B. The middle portion 130M is connected between the top portion 130T and the bottom portion 130B. The bottom portion 130B may include the upper bottom portion 130BU and the lower bottom portion 130BL. The size of the lower bottom portion 130BL is smaller than that of the upper bottom portion 130BU, facilitating the insertion of the abutting structure 130 into the mounting hole 120H from the bottom. The top portion 130T is adapted to abut against the lever member 111, serving as the abutting surface of the abutting structure 130 to be in contact with the protruding end 111P of the lever member 111. Regarding the method for disposing the abutting structure 130 in the touch panel base 120, the abutting structure 130 can be inserted into the mounting hole 120H in parallel to the extension direction of the mounting hole 120H. After the bottom portion 130B passes through the mounting holes 120H, the abutting structure 130 can be rotated approximately 90 degrees, at which point the middle portion 130M is secured in one of the accommodating portions 120H1, 120H2 and 120H3, and the top portion 130T is exposed on the mounting hole 120H.

Through the size of the middle portion 130M being smaller than that of the top portion 130T and the bottom portion 130B, the abutting structure 130 can be stably positioned within the mounting hole 120H. Specifically, in a transverse direction (e.g., perpendicular to the arrangement direction of accommodating portions 120H1, 120H2 and 120H3), the width of the top portion 130T is greater than the width of the bottom portion 130B, and the width of the bottom portion 130B is greater than the width of the middle portion 130M. Additionally, the abutting structure 130 may be designed to include the through hole 130H located between the middle portion 130M and the upper bottom portion 130BU of the bottom portion 130B. The through hole 130H can provide elastic deformation when the middle portion 130M rotates to latch into one of the accommodating portions 120H1, 120H1 and 120H3, facilitating smoother installation of the abutting structure 130.

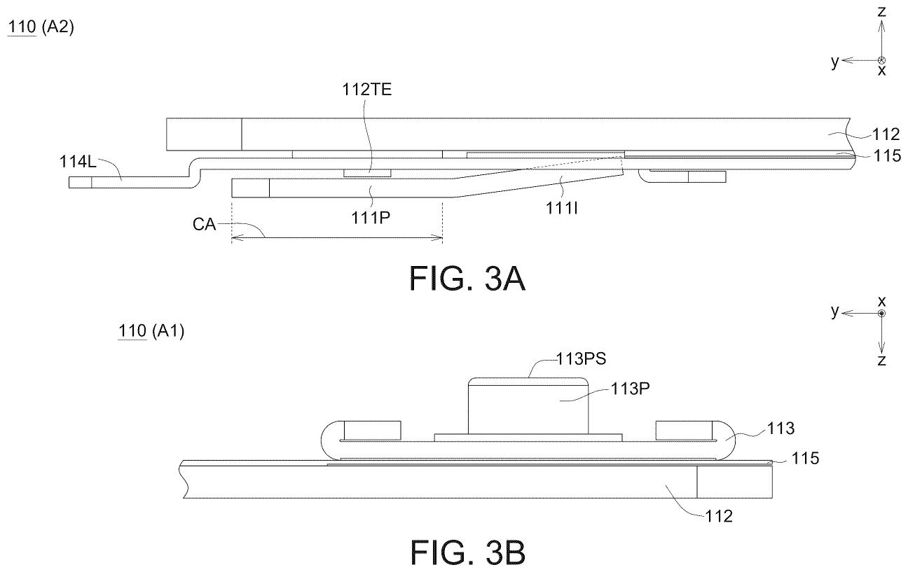

Please further refer to FIG. 3A and FIG. 3B, where FIG. 3A illustrates a side view of the partial area A2 of the touch panel module 110 in FIG. 1B, and FIG. 3B illustrates a side view of the partial area A1 of the touch panel module 110 in FIG. 1A.

In a side view, the lever member 111 may include the flat portion 111P and the inclined portion 1111 which are connected, wherein the flat portion 111P and the inclined portion 1111 are non-parallel and form an angle, such that the lever member 111 is a polyline structure. The inclined portion 1111 is adhered to the circuit board 112 via the flexible sheet 115. The flat portion 111P is spaced from the flexible sheet 115 and the circuit board 112. When the touch panel module 110 is not pressed, there is a gap between the flat portion 111P and the triggering element 112TE of the circuit board 112. When the touch panel module 110 is pressed, the flat portion 111P is in contact with the triggering element 112TE to activate the corresponding touch function.

When the touch panel module 110 is disposed on the touch panel base 120, the abutting structure 130 in the touch panel base 120 may abut against the flat portion 111P of the lever member 111. In this embodiment, the abutting structure 130 may abut against the flat portions 111P formed at both ends of the lever member 111, as shown in FIG. 1A. Specifically, corresponding to the abutting structure 130 being at different positions of the touch panel base 120 (e.g., held in the accommodating portion 120H1, 120H2, or 120H3), the abutting structure 130 and the flat portion 111P correspondingly have different abutting areas, thereby creating different moments of force and resulting in different pressing hand-feelings when the lever member 111 is in contact with the triggering element 112TE.

Specifically, the flat portion 111P has the contact area CA with the the abutting structure 130. When the contact point between the abutting structure 130 and the flat portion 111P within the contact area CA is closer to the inclined portion 1111 (e.g., when the abutting structure 130 is located at the accommodating portion 120H1), The moment of force formed by using the inclined portion 1111 attached to the circuit board 112 as a fulcrum is smaller, so that the touch panel assembly provides a heavier pressing hand-feeling. Conversely, when the contact point between the abutting structure 130 and the flat portion 111P within the contact area CA is farther from the inclined portion 1111 (e.g., when the abutting structure 130 is located at the accommodating portion 120H3), the moment of force formed by using the inclined portion 1111 adhered to the circuit board 112 as the fulcrum is larger, so that the touch panel assembly provides a lighter pressing hand-feeling. Additionally, when the contact point between the abutting structure 130 and the flat portion 111P within the contact area CA is located at the middle portion of the flat portion 111P (e.g., when the abutting structure 130 is located at the accommodating portion 120H2), the moment of force formed by using the inclined portion 1111 adhered to the circuit board 112 as the fulcrum is moderate, so that the touch panel assembly provides a medium pressing hand-feeling.

Additionally, corresponding to the base fixing holes 120R of the touch panel base 120 as shown in FIG. 2A, the supporting strip 113 may include a plurality of protruding structures 113P, each protruding structure 113P corresponding with one base fixing hole 120R. When the touch panel module 110 is disposed on the touch panel base 120, the protruding structures 113P can pass through the base fixing holes 120R to secure the touch panel module 110 to the touch panel base 120. For example, the protruding structures 113P may snap-fit into the base fixing holes 120R, or they may be fixed using screws into the base fixing holes 120R. For example, screw holes may be designed on the surface 113PS of the protruding structures 113P, depending on the required level of fastening.

As described above, in the embodiments of the present invention, the touch panel assembly includes a touch panel module that is supported by the abutting structure installed within the touch panel base, providing feedback when the touch panel module is pressed. Furthermore, the abutting structure is detachable and optionally mounted at a plurality of positions within the touch panel base. Depending on the position of the abutting structure within the touch panel base, the contact point between the abutting structure and the lever member of the touch panel module varies, resulting in different pressing hand-feelings when the lever member is in contact with the triggering element. This adjustability allows the pressing feedback of the touch panel module to be fine-tuned, achieving a more balanced operation of the touch panel assembly.

It will be apparent to those skilled in the art that various modifications and variations may be made to the disclosed embodiments. It is intended that the specification and examples be considered as exemplars only, with a true scope of the disclosure being indicated by the following claims and their equivalents.

What is claimed is:

1. A touch panel assembly, comprising:
a touch panel module, including a lever member and a circuit board, wherein the lever member is adhered to the circuit board, the circuit board includes a triggering element, and when the touch panel module is pressed, the lever member is in contact with the triggering element;
a touch panel base, wherein the touch panel module is arranged on the touch panel base; and
an abutting structure, disposed in the touch panel base and abutting against the lever member, wherein the abutting structure is detachable and optionally mounted at a plurality of different positions of the touch panel base;
wherein, corresponding to the abutting structure being at the different positions of the touch panel base, the abutting structure abuts on different portions of the lever member, so that different pressing hand-feelings are provided when the lever member is in contact with the triggering element.

2. The touch panel assembly according to claim 1, wherein the touch panel base has a mounting hole corresponding to the abutting structure, the mounting hole includes a plurality of accommodating portions, and the abutting structure is adapted to be fixed within each of the accommodating portions.

3. The touch panel assembly according to claim 2, wherein the abutting structure includes a top portion, a middle portion and a bottom portion, the middle portion is connected between the top portion and the bottom portion, the top portion is adapted to abut against the lever member, when the bottom portion passes through the mounting hole and rotates, the middle portion is adapted to be engaged with one of the accommodating portions and the top portion is exposed on the mounting hole.

4. The touch panel assembly according to claim 3, wherein in a transverse direction, a width of the top portion is greater than a width of the bottom portion, and the width of the bottom portion is greater than a width of the middle portion.

5. The touch panel assembly according to claim 1, wherein the touch panel module includes a supporting strip, the supporting strip is adhered to the circuit board, the touch panel base has a base fixing hole, and the supporting strip has a protrusion structure corresponding to the base fixing hole, when the touch panel module is arranged on the touch panel base, the protrusion structure is inserted into the base fixing hole.

6. The touch panel assembly according to claim 5, wherein the protrusion structure is fixed in the base fixing hole.

7. The touch panel assembly according to claim 5, wherein the protrusion structure is screwed to the base fixing hole.

8. The touch panel assembly according to claim 1, wherein the circuit board includes an electronic component, the touch panel base has a hollow area, and when the touch panel module is arranged on the touch panel base, the electronic component is arranged in the hollow area.

9. The touch panel assembly according to claim 1, wherein in a side view, the lever member includes a flat portion and an inclined portion, the flat portion and the inclined portion are connected, the inclined portion is adhered to the circuit board, the abutting structure abuts against the flat portion, and corresponding to the abutting structure being at the different positions of the touch panel base, there are different abutment positions between the abutting structure and the flat portion.

10. The touch panel assembly according to claim 1, wherein the abutting structure is formed by rubber material.
